(19) United States
(12) Patent Application Publication
(10) Pub. No.: US 2015/0149243 A1
(43) Pub. Date: May 28, 2015

(54) METHOD AND SYSTEM FOR DISTRIBUTING CONSUMER ANALYTICS TO A POINT OF SALE DEVICE

(71) Applicant: MasterCard International Incorporated, Purchase, NY (US)

(72) Inventors: Kenny UNSER, Fairfield, CT (US); Serge Bernard, Danbury, CT (US); Nikhil Malgatti, Stamford, CT (US)

(73) Assignee: MasterCard International Incorporated, Purchase, NY (US)

(21) Appl. No.: 14/087,224

(22) Filed: Nov. 22, 2013

(51) Int. Cl. G06Q 30/02

(52) U.S. Cl. CPC G06Q 30/0201
USPC 705/7.29

(57) ABSTRACT

A method for distributing consumer analytics to a point-of-sale device includes: storing a plurality of consumer profiles, each profile including data related to a consumer including a consumer identifier associated with the related consumer, a plurality of consumer characteristics, and a plurality of transaction data entries, each entry corresponding to a payment transaction involving the related consumer and including transaction data; receiving a consumer profile request, the request including a specific consumer identifier and one or more requested consumer metrics; identifying a specific consumer profile where the included consumer identifier corresponds to the specific consumer identifier; calculating the requested consumer metrics for the consumer related to the specific consumer profile based on the transaction data included in the plurality of transaction data entries included in the specific consumer profile; and transmitting the consumer characteristics included in the specific consumer profile and the calculated consumer metrics in response to the request.

### FIELD

The present disclosure relates to the distribution of consumer analytics to a point of sale device, specifically the calculation of consumer metrics based on transaction data and the fulfillment thereof to a request for consumer metrics for a particular consumer or a consumer associated with a particular set of consumer characteristics.

### BACKGROUND

Consumers are often targets for advertisers, merchants, content providers, offer providers, retailers, and other entities. These entities may reach out to consumers using advertisements, offers, coupons, deals, and other mechanisms in an effort to encourage the consumer to engage in a transaction or other business with the entity. In an effort to increase success with consumers, entities may often target specific consumers based on a variety of criteria. For example, some offer providers may target consumers for the distribution of an offer who have a history of redeeming similar offers. Methods and systems for targeting of consumers based on offer redemption can be found in U.S. patent application Ser. No. 13/793,616, entitled “Method and System for Offer Targeting Based on Offer Redemption,” by Andrea Gilman et al., filed on Mar. 11, 2013, which is herein incorporated by reference in its entirety.

However, such systems and methods often utilize data that may be incomplete, and thus may not have a high accuracy. For example, a consumer may redeem offers for two electronic items, and thus be targeted for distribution of future offers for electronics. However, the purchases may have been gifts for a specific occasion, with the consumer themselves not typically interested in electronics. In traditional methods and systems, the consumer may continue to receive offers for electronics, which may continue to go unredeemed. This may result in increased expense for the offer provider, as well as decreased business for associated merchants.

As a result, offer providers and other entities may benefit from utilizing additional information regarding a consumer's transaction behavior and history. However, many consumers may be reluctant to provide access to this information to third parties. Thus, there is a need for a technical solution to provide consumer analytics for consumers based on consumer transaction history, while also maintaining consumer privacy and security.

### SUMMARY

The present disclosure provides a description of systems and methods for distributing consumer analytics to a point of sale device.

A method for distributing consumer analytics to a point-of-sale device includes: storing, in a database, a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer and including transaction data; receiving, by a receiving device, a consumer profile request, wherein the consumer profile request includes at least a specific consumer identifier and one or more requested consumer metrics; identifying, in the database, a specific consumer profile where the included consumer identifier corresponds to the specific consumer identifier; calculating, by a processing device, the one or more requested consumer metrics for the consumer related to the specific consumer profile based on the transaction data included in the plurality of transaction data entries included in the specific consumer profile; and transmitting, by a transmitting device, at least the consumer characteristics included in the specific consumer profile and the calculated one or more requested consumer metrics in response to the received consumer profile request.

Another method for distributing consumer analytics to a point-of-sale device includes: storing, in a database, a plurality of microsegment profiles, wherein each microsegment profile includes data related to a plurality of consumers including at least a plurality of consumer identifiers, each consumer identifier associated with one of the plurality of related consumers, a plurality of consumer characteristics corresponding to each of the plurality of related consumers, and a plurality of transaction data entries, each transaction data entry corresponding to a payment transaction involving one of the plurality of related consumers and including transaction data; receiving, by a receiving device, a consumer profile request, wherein the consumer profile request includes at least a specific consumer identifier and one or more requested consumer metrics; identifying, in the database, a specific microsegment profile where one of the included plurality of consumer identifiers corresponds to the specific consumer identifier; calculating, by a processing device, the one or more requested consumer metrics for a consumer related to the specific microsegment profile based on the transaction data included in the plurality of transaction data entries included in the specific microsegment profile; and transmitting, by a transmitting device, at least the plurality of consumer characteristics included in the specific microsegment profile and the calculated one or more requested consumer metrics in response to the received consumer profile request.

A system for distributing consumer analytics to a point-of-sale device includes a database, a receiving device, a processing device, and a transmitting device. The database is configured to store a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer and including transaction data. The receiving device is configured to receive a consumer profile request, wherein the consumer profile request includes at least a specific consumer identifier and one or more requested consumer metrics. The processing device is configured to: identify, in the database, a specific consumer profile where the included consumer identifier corresponds to the specific consumer identifier; and calculate the one or more requested consumer metrics for the consumer related to the specific consumer profile based on the transaction data included in the plurality of transaction data entries included in the specific consumer profile. The transmitting device is configured to transmit at least the consumer characteristics included in the specific consumer profile and the calculated one or more requested consumer metrics in response to the received consumer profile request.

Another system for distributing consumer analytics to a point-of-sale device includes a database, a receiving device, a processing device, and a transmitting device. The database is configured to store a plurality of microsegment profiles, wherein each microsegment profile includes data related to a plurality of consumers including at least a plurality of consumer identifiers, each consumer identifier associated with one of the plurality of related consumers, a plurality of consumer characteristics corresponding to each of the plurality of related consumers, and a plurality of transaction data entries, each transaction data entry corresponding to a payment transaction involving one of the plurality of related consumers and including transaction data. The receiving device is configured to receive a consumer profile request, wherein the consumer profile request includes at least a specific consumer identifier and one or more requested consumer metrics. The processing device is configured to: identify, in the database, a specific microsegment profile where one of the included plurality of consumer identifiers corresponds to the specific consumer identifier; and calculate the one or more requested consumer metrics for a consumer related to the specific microsegment profile based on the transaction data included in the plurality of transaction data entries included in the specific microsegment profile. The transmitting device is configured to transmit at least the plurality of consumer characteristics included in the specific microsegment profile and the calculated one or more requested consumer metrics in response to the received consumer profile request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for identifying and distributing consumer analytics to a point of sale in accordance with exemplary embodiments.

FIG. 2 is a block diagram illustrating the processing server of FIG. 1 for the identification and distribution of consumer analytics in accordance with exemplary embodiments.

FIGS. 3A-3C are a flow diagram illustrating a process for identifying and distributing consumer analytics and the use thereof to identify targeted content for distribution to a consumer in accordance with exemplary embodiments.

FIG. 4 is a diagram illustrating the linking of a consumer profile to a microsegment profile in accordance with exemplary embodiments.

FIG. 5 is a flow diagram illustrating a process for identifying and distributing consumer analytics while maintaining consumer privacy in accordance with exemplary embodiments.

FIGS. 6 and 7 are flow charts illustrating exemplary methods for distributing consumer analytics to a point of sale device in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems that do not possess any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the systems and methods discussed herein may not possess the PII or be able to decrypt the encrypted PII.

Microsegment—A representation of a group of consumers that is granular enough to be valuable to advertisers, marketers, offer providers, merchants, retailers, etc., but still maintain a high level of consumer privacy without the use or obtaining of personally identifiable information. Microsegments may be given a minimum or a maximum size. A minimum size of a microsegment would be at a minimum large enough so that no entity could be personally identifiable, but small enough to provide the granularity needed in a particular circumstance. Microsegments may be defined based on geographical or demographical information, such as age, gender, income, marital status, postal code, income, spending propensity, familial status, etc., behavioral variables, or any other suitable type of data, such as discussed herein. The granularity of a microsegment may be such that behaviors or data attributed to members of a microsegment may be similarly attributable or otherwise applied to consumers having similar characteristics. In some instances, microsegments may be grouped into an audience. An audience may be any grouping of microsegments, such as microsegments having a common data value, microsegments encompassing a plurality of predefined data values, etc. In some instances, the size of a microsegment may be dependent on the application. An audience based on a plurality of microsegments, for instance, might have ten thousand entities, but the microsegments would be aggregated when forming the audience and would not be discernible to anyone having access to an audience. Additional detail regarding microsegments and audiences may be found in U.S. patent application Ser. No. 13/437,987, entitled “Protecting Privacy in Audience Creation,” by Curtis Villars et al., filed on Apr. 3, 2012, which is herein incorporated by reference in its entirety.

### System for Distributing Consumer Analytics to a Point of Sale

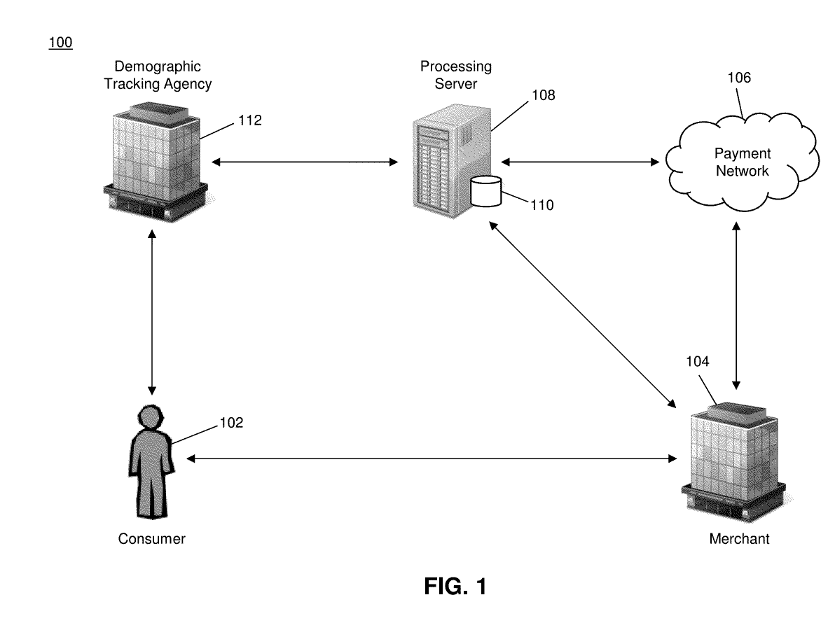

FIG. 1 illustrates a system 100 for identifying and distributing consumer analytics based on consumer transaction history to a point of sale device.

A consumer 102 may engage in one or more payment transactions at a merchant 104. The payment transaction or transactions may be conducted in person (e.g., at a physical location of the merchant 104), or remotely, such as via the Internet, telephone, by mail, etc. The transaction may be processed via a payment network 106. The payment network 106 may transmit a copy of the authorization request or transaction data included therein to a processing server 108, discussed in more detail below. The processing server 108 may store the transaction data in a consumer profile of a consumer database 110, also discussed in more detail below, associated with the consumer 102. In an exemplary embodiment, the transaction data may only be stored in a consumer profile associated with the particular consumer 102 with the permission of the consumer 102.

The processing server 108 may receive demographic characteristics associated with the consumer 102 from a demographic tracking agency 112 or other third party. The demographic characteristics may include: age, gender, income, marital status, familial status, residential status, occupation, education, zip code, postal code, street address, county, city, state, country, etc. The processing server 108 may store the demographic characteristics in the consumer profile associated with the consumer 102. In an exemplary embodiment, the consumer profile associated with the consumer 102 may not include any personally identifiable information. In some instances, the consumer 102 may be grouped with a plurality of consumers having similar or the same demographic characteristics, such as a microsegment.

The processing server 108 may then, as discussed in more detail below, identify a plurality of consumer metrics based on the transaction history of the consumer 102 and stored in the consumer profile in the consumer database 110. The processing server 108 may transmit requested consumer metrics for the consumer 102 to the merchant 104, which the merchant 104 may use to provide additional services to the consumer 102, such as offers, discounts, deals, loyalty programs, etc. In some instances, the merchant 104 may request one or more consumer metrics from the processing server 108 when the consumer 102 visits the merchant 104. The consumer metrics may be any metric or measurement associated with the consumer 102 based on at least the consumer's transaction history, such as spending behaviors, spending propensities, consumer models, consumer trends, predictive behaviors, etc.

In some embodiments, the processing server 108 may not identify consumer metrics for the consumer 102 until a request is received from the merchant 104 or another third party. In an exemplary embodiment, the processing server 108 may require consent of the consumer 102 prior to providing consumer metrics associated with the consumer 102 to a third party. In some instances, the processing server 108 may use microsegments, which may significantly increase the privacy and security of the consumer 102 and the consumer's information.

As discussed in more detail below, the processing server 108 may group consumers together in a plurality of microsegments. Each microsegment may include consumers having similar consumer characteristics, such as those demographic characteristics received from the demographic tracking agency 112. A microsegment may represent a sufficient number of consumers such that no consumer 102 included in a microsegment may be personally identifiable. In such an embodiment, the processing server 108 may identify a microsegment based on a consumer identifier associated with the consumer 102 or a plurality of consumer characteristics, such as consumer characteristics associated with the consumer 102. The processing server 108 may then identify corresponding consumer metrics associated with the microsegment.

Methods and systems discussed herein may provide for more accurate consumer metrics based on more comprehensive transaction data. In addition, the use of consumer characteristics may provide for even further detail that may be used in targeting consumers for the distribution of content to consumers, such as at a point of sale of the merchant 104. In addition, using consumer characteristics may enable the processing server 108 to utilize microsegments, which may provide for accurate consumer metrics while maintaining a high level of consumer privacy.

### Processing Server

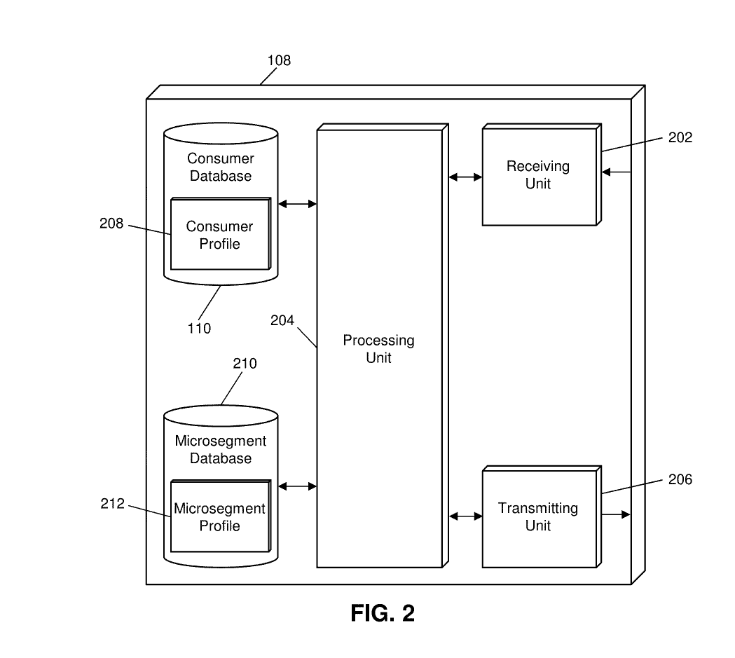

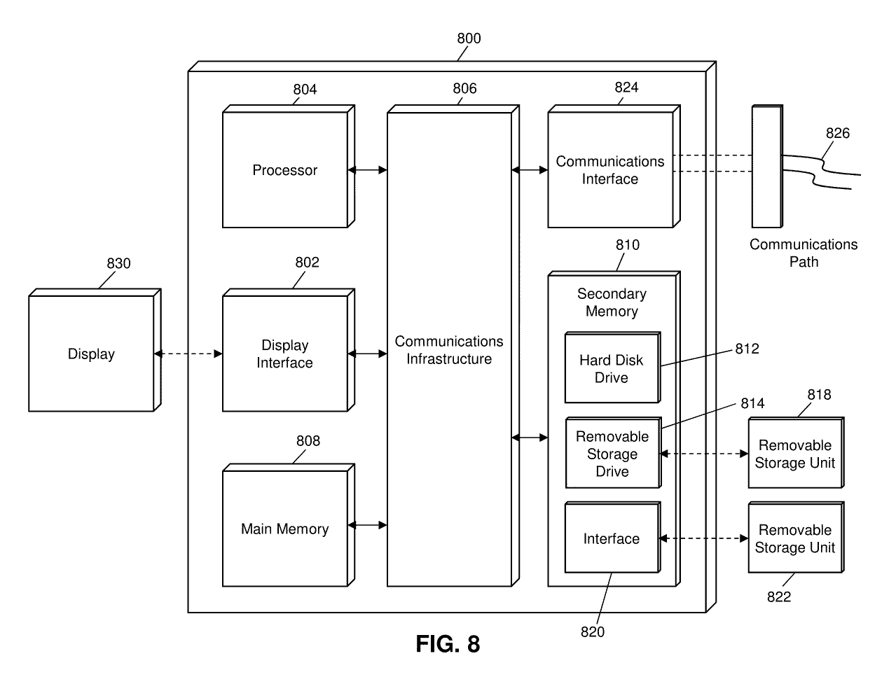

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 800 illustrated in FIG. 8 and discussed in more detail below may be a suitable configuration of the processing server 108.

The processing server 108 may include a receiving unit 202. The receiving unit 202 may be configured to receive data over one or more networks via one or more network protocols. The receiving unit 202 may be configured to receive transaction data from the payment network 106, demographic characteristic data from the demographic tracking agency 112, and a request for consumer metrics from the merchant 104 or other third party.

The processing server 108 may also include a processing unit 204. The processing unit 204 may be configured to store received transaction data in the consumer database 110 and/or a microsegment database 210. The transaction data may be stored in a corresponding consumer profile 208 or microsegment profile 212 that includes or is related to a consumer 102 involved in the corresponding payment transaction. The transaction data may be stored as a plurality of transaction data entries in the corresponding profile, each transaction data entry including data related to a payment transaction involving the related consumer 102 or a consumer of the related microsegment. Each transaction data entry may include data related to the corresponding payment transaction, such as a consumer identifier, merchant identifier, transaction amount, transaction time and/or date, geographic location, merchant name, product data, coupon or offer data, a point-of-sale identifier, or other suitable information as will be apparent to persons having skill in the relevant art. In some embodiment, each transaction data entry may also include demographic characteristics for the consumer 102 involved in the corresponding payment transaction.

Each consumer profile 208 stored in the consumer database 110 may include data related to a consumer (e.g., the consumer 102), including at least a consumer identifier associated with the related consumer 102, a plurality of consumer characteristics, and a plurality of transaction data entries for payment transactions involving the related consumer 102. The consumer identifier may be a unique value suitable for identifying the related consumer 102, such as a consumer identification number, a phone number, e-mail address, payment account number, street address, etc., or other suitable value as will be apparent to persons having skill in the relevant art. In an exemplary embodiment, each consumer profile 208 may not include personally identifiable information unless expressly consented to by the related consumer 102. In some embodiments, each consumer profile 208 may be associated with a specific set of consumer characteristics and may accordingly be related to a generic consumer of those characteristics rather than an actual consumer 102.

Each microsegment profile 212 stored in the microsegment database 210 may similarly include a plurality of consumer identifiers, a plurality of consumer characteristics, and a plurality of transaction data entries. Each consumer identifier of the plurality of consumer identifiers may be associated with a consumer 102 included in the corresponding microsegment. Each of the plurality of consumer characteristics may correspond to each of the consumers 102 included in the corresponding microsegment. In some instances, the consumer characteristics may be grouped (e.g., bucketed) such that the microsegment includes a number of consumers such that no individual consumer is personally identifiable. The transaction data entries may correspond to payment transactions involving any of the consumers included in the corresponding microsegment.

In some embodiments, the processing server 108 may include a separate transaction database. The transaction database may be configured to store the received transaction data as a plurality of transaction data entries. In such an embodiment, the processing unit 204 may be configured to identify transaction data entries corresponding to an identified consumer profile 208 and/or microsegment profile 212, such as by using the included consumer identifier or identifiers.

The processing unit 204 may be configured to calculate and/or identify consumer metrics for a consumer profile 208 and/or a microsegment profile 212. The consumer metrics may be based on at least the transaction data included in each of the plurality of transaction data entries included in the corresponding profile. In some embodiments, the consumer metrics may be further based on the demographic characteristics included in the corresponding profile. In instances where the processing unit 204 may identify consumer metrics for a microsegment profile 212, the metrics may be based on consumers similar to a specific consumer 102, and thus be accurate to the consumer 102 without impeding on the privacy and security of the consumer 102.

In some embodiments, the processing unit 204 may be configured to identify only those consumer metrics requested by a third party as included in a request for consumer metrics received by the receiving unit 202. In other embodiments, the processing unit 204 may identify consumer metrics for a profile at predetermined periods of time. The predetermined periods of time may include regular time intervals (e.g., daily, weekly, monthly, etc.), the occurrence of specific events (e.g., a new transaction data entry added to the corresponding profile), or other periods as will be apparent to persons having skill in the relevant art.

The processing server 108 may further include a transmitting unit 206. The transmitting unit 206 may be configured to transmit data over one or more networks via one or more network protocols. The transmitting unit 206 may transmit the identified consumer metrics to the merchant 104 or other third party, such as in response to a request for consumer metrics previously received by the receiving unit 202.

### Process for Identifying, Distributing, and Utilizing Consumer Metrics

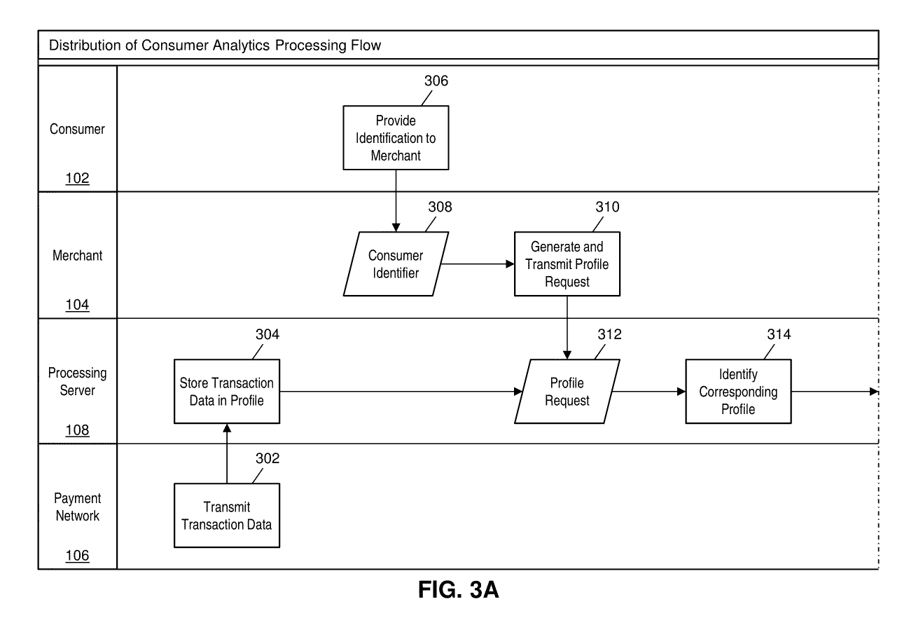

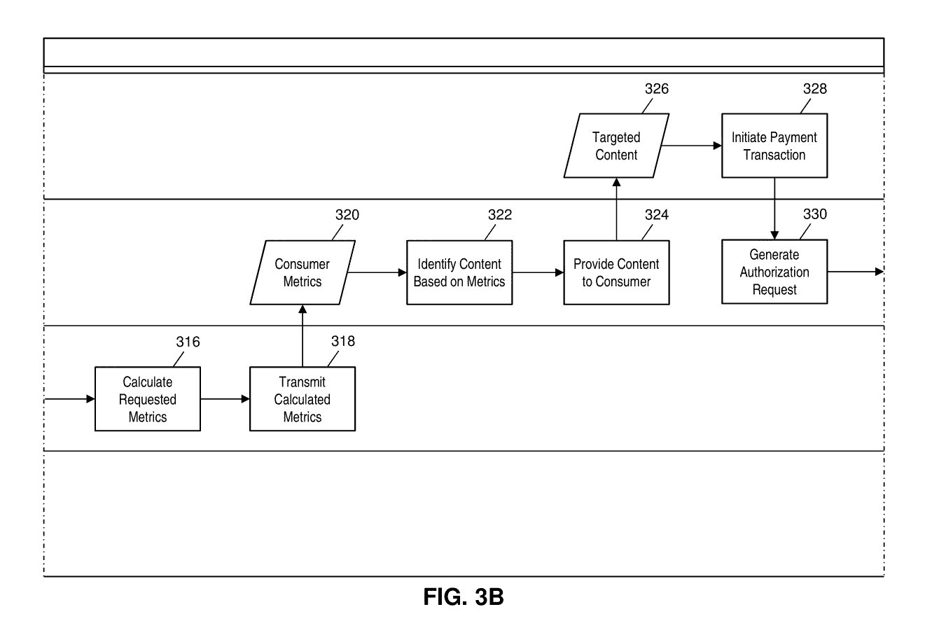

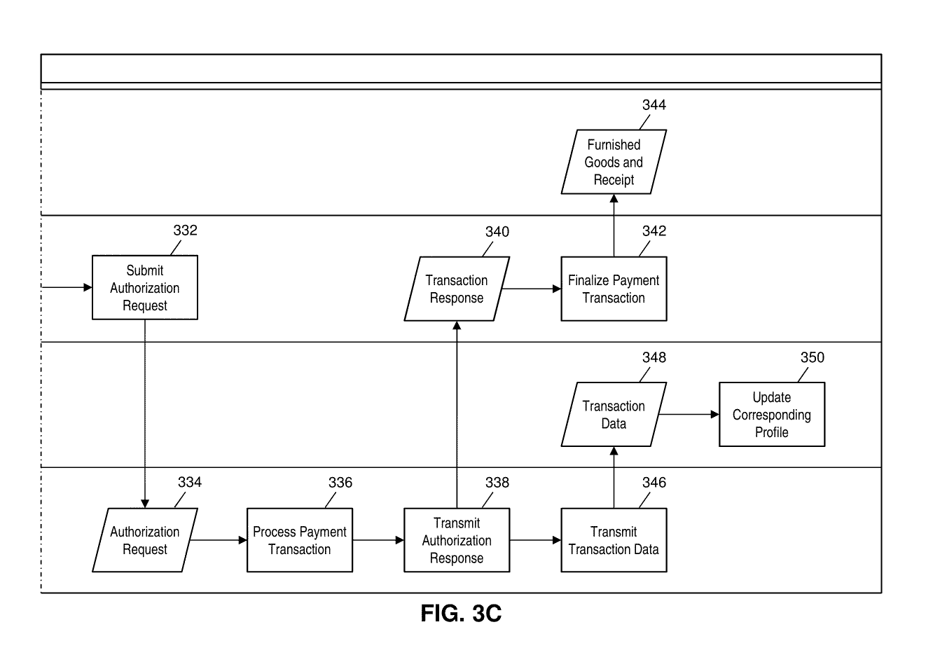

FIGS. 3A-3C illustrate a processing flow for the identification and distribution of consumer analytics to a merchant point of sale device and the use thereof to distribute content to a consumer for use in conducting a payment transaction.

In step 302, the payment network 106 may transmit transaction data for a payment transaction involving the consumer 102 to the processing server 108. The transaction data may include a transaction amount, merchant data, product data, geographic location information, a transaction time and/or date, and/or any other suitable data as will be apparent to persons having skill in the relevant art. In step 304, the receiving unit 202 of the processing server 108 may receive the transaction data, which may be stored in a corresponding consumer profile 208 related to the consumer 102 involved in the payment transaction.

In step 306, the consumer 102 may visit the merchant 104 and provide identification to the merchant 104. The identification may include a consumer identifier associated with the consumer 102, and may be provided to the merchant 104 via a payment card, an identification card, a mobile communication device (e.g., a cellular phone, smart phone, etc.) or any other suitable method as will be apparent to persons having skill in the relevant art. For example, the consumer 102 may connect a mobile device to a local area network (e.g., Wi-Fi) of the merchant 104, may scan a machine-readable code displayed by the merchant 104, may swipe a payment card or loyalty card at the merchant 104, may log in to a website of the merchant 104, etc.

In step 308, the merchant 104 may identify the consumer identifier associated with the consumer 102 upon receiving the identification from the consumer 102. In step 310, the merchant 104 may generate a profile request for one or more consumer metrics, wherein the profile request identifies one or more metrics requested by the processing server 108 and the consumer identifier associated with the consumer 102. The merchant 104 may transmit the profile request to the processing server 108, which may receive the profile request, via the receiving unit 202, in step 312.

In step 314, the processing server 108 may identify a consumer profile 208 associated with the consumer 102 in the consumer database 110 based on the consumer identifier included in the profile request for consumer metrics. In instances where microsegment profiles 212 may be used, the processing server 108 may identify a microsegment profile 212 where one of the plurality of consumer identifiers is the consumer identifier included in the request for consumer metrics. In step 316, the processing unit 204 of the processing server 108 may calculate the one or more metrics identified in the request for consumer metrics, wherein the one or more metrics are based on at least the transaction data included in each of the plurality of transaction data entries included in the identified profile.

In step 318, the transmitting unit 206 of the processing server 108 may transmit the calculated consumer metrics to the merchant 104 as a response to the request for consumer metrics. In some embodiments, the processing unit 204 may filter, scrub, or otherwise modify the calculated consumer metrics prior to transmission to the merchant 104 to prevent the distribution of personally identifiable information of the consumer 102 without prior consent of the consumer 102. In step 320, the merchant 104 may receive the requested consumer metrics.

In step 322, the merchant 104 may identify content, such as a discount for one or more goods or services available for purchase by the merchant 104, for distribution to the consumer 102 based on the calculated consumer metrics. For example, the merchant 104 may identify a coupon for the purchase of a new movie if the metrics indicate that the consumer 102 has a high propensity for buying new movies that have released for purchased. In step 324, the merchant 104 may distribute the content to the consumer 102. The content may be distributed to the consumer 102 at the point of sale, to a mobile device associated with the consumer 102, or by any suitable method as will be apparent to persons having skill in the relevant art.

In step 326, the consumer 102 may receive and view the targeted content. In step 328, the consumer 102 may then initiate a payment transaction with the merchant 104 (e.g., using the targeted offer provided by the merchant 104). In step 330, the merchant 104 may enter transaction data for the payment transaction in a point of sale and may generate (e.g., via an acquirer associated with the merchant 104) an authorization request for the payment transaction. The authorization request may include transaction data, the consumer identifier associated with the consumer 102, and a transaction amount. In step 332, the merchant 104, or another entity on behalf of the merchant 104 (e.g., an acquirer), may submit the authorization request to the payment network 106 for processing.

In step 334, the payment network 106 may receive the authorization request. In step 336, the payment network 106 may process the payment transaction using methods and systems for processing payment transactions that will be apparent to persons having skill in the relevant art. As part of the processing, the payment network 106 may generate an authorization response indicating the approval of the payment transaction. In step 338, the payment network 106 may transmit the authorization response indicating the approval to the merchant 104.

In step 340, the merchant 104 may receive the response from the payment network 106 and may then, in step 342, finalize the payment transaction. Finalizing of the payment transaction may include furnishing the transacted-for goods or services to the consumer 102 and/or providing the consumer 102 with a receipt for the payment transaction, which the consumer 102 may receive, in step 344.

Following the processing of the payment transaction and transmitting of the authorization response to the merchant 104, the payment network 106 may, in step 346, transmit transaction data for the processed payment transaction to the processing server 108. In step 348, the receiving unit 202 of the processing server 108 may receive the transaction data including the consumer identifier associated with the consumer 102. In step 350, the processing unit 204 may identify the consumer profile 208 associated with the consumer 102 and add a new transaction data entry corresponding to the payment transaction based on the newly received transaction data.

### Linking Consumer Profiles to Microsegment Profiles

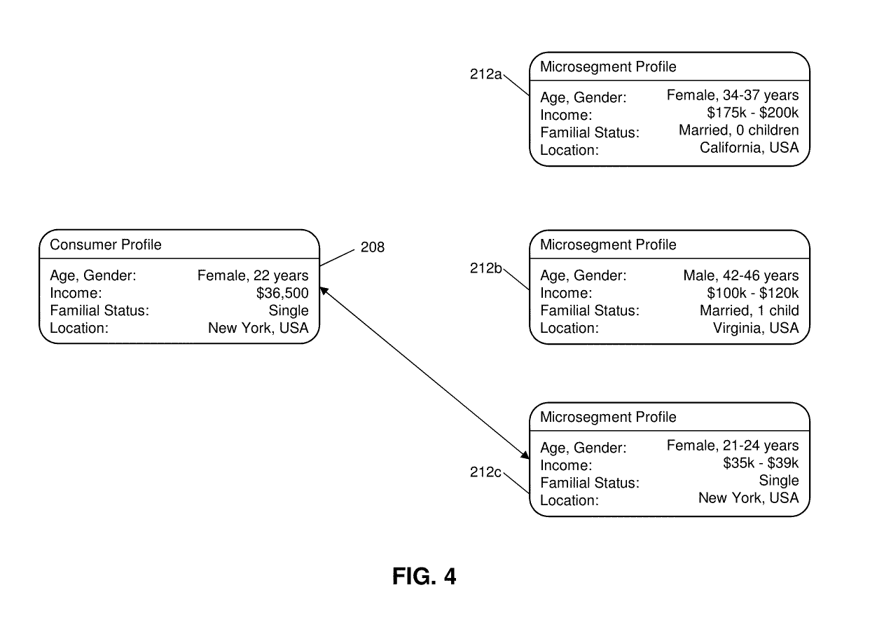

FIG. 4 illustrates the linking of a consumer profile 208 to a microsegment profile 212 based on consumer characteristics.

As discussed above, a consumer profile 208 related to a specific consumer 102 may include a plurality of consumer characteristics associated with the related consumer 102. For example, the consumer profile 208 illustrated in FIG. 4 may be related to a consumer 102 that is a female, is 22 years old, has an income of $36,500, is single, and lives in New York. In an exemplary embodiment, the consumer characteristics included in the consumer profile 208 may not be personally identifiable. In some instances, the processing server 108 may place the related consumer 102 in a microsegment profile 212, in order to provide for additional consumer security and privacy.

The microsegment database 210 of the processing server 108 may store a plurality of microsegment profiles 212, illustrated in FIG. 4 as microsegment profiles 212a, 212b, and 212c. Each microsegment profile 212 may include a plurality of consumer characteristics associated with consumers included in the respective microsegment profile 212. In some instances, the consumer characteristics may be bucketed and/or grouped such that the respective microsegment profile 212 may include a sufficient number of consumers such that no consumer 102 is personally identifiable or that a predetermined level of consumer privacy is maintained. For example, each microsegment profile 212 may have consumer characteristics set such that the microsegment profile 212 corresponds to at least ten unique consumers 102.

The processing unit 204 may associate the consumer 102 related to the consumer profile 208 with one of the microsegment profiles 212 based on a correspondence between the demographic characteristics associated with the consumer 102 and the demographic characteristics included in the microsegment profiles 212. In the example illustrated in FIG. 4, the consumer 102 related to the consumer profile 208 may be included in the microsegment profile 212c, as her consumer characteristics are within the demographic characteristics of the microsegment profile 212c.

### Process for Identifying and Distributing Consumer Metrics

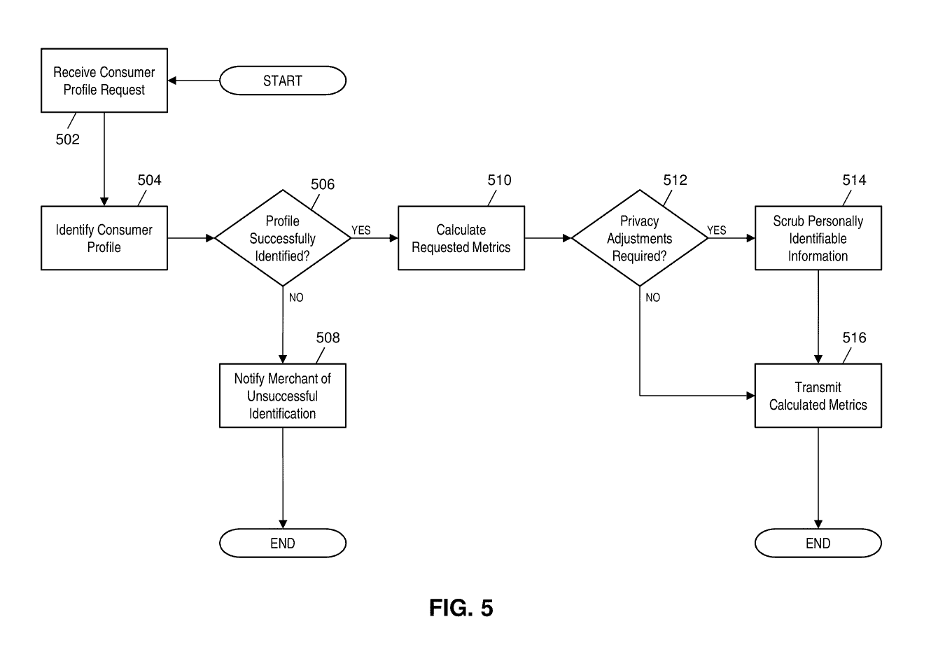

FIG. 5 illustrates a process for identifying and distributing consumer metrics for a consumer while maintaining consumer privacy using the processing server 108 of the system 100.

In step 502, the receiving unit 202 of the processing server 108 may receive a request for a consumer profile 208 (e.g., from the merchant 104). The request may identify one or more consumer metrics and may include a consumer identifier corresponding to the consumer 102 for which the related consumer profile 208 is requested. In step 504, the processing unit 204 may identify a consumer profile 208 stored in the consumer database 110 where the included consumer identifier corresponds to the consumer identifier included in the received consumer profile request.

In step 506, the processing unit 204 may determine if a consumer profile 208 was successfully identified (e.g., a consumer profile 208 related to the consumer 102 exists in the consumer database 110). If no consumer profile 208 is identified, then, in step 508, the transmitting unit 206 of the processing server 108 may transmit a notification to the merchant 104 or other entity requesting the consumer profile 208 that the identification of a consumer profile 208 related to the consumer 102 was unsuccessful.

If a consumer profile 208 is identified by the processing unit 204, then, in step 510, the processing unit 204 may calculate the consumer metrics specified in the received consumer profile request. In step 512, the processing unit 204 may determine if privacy adjustments are required prior to transmitting the consumer profile 208 and/or the calculated consumer metrics to the merchant 104. For example, the merchant 104 may request consumer characteristics associated with the consumer 102. In some instances, the processing server 108 may not transmit consumer characteristics associated with the specific consumer 102 without prior consent of the consumer 102. In such an instance, the processing unit 204 may identify a microsegment to which the consumer 102 would belong and use the demographic characteristics of the identified microsegment for transmission to the merchant 104.

If privacy adjustments are required, then, in step 514, the processing unit 204 may perform necessary actions to scrub, remove, or otherwise modify the consumer profile 208 and/or consumer metrics to remove any personally identifiable information or other information as necessary. Once the information has been modified or removed, or if no privacy adjustments were required, then, in step 516, the transmitting unit 206 of the processing server 108 may transmit the calculated consumer metrics and/or the consumer profile 208 to the merchant 104 or other entity that submitted the received consumer profile request.

### First Exemplary Method for Distributing Consumer Analytics

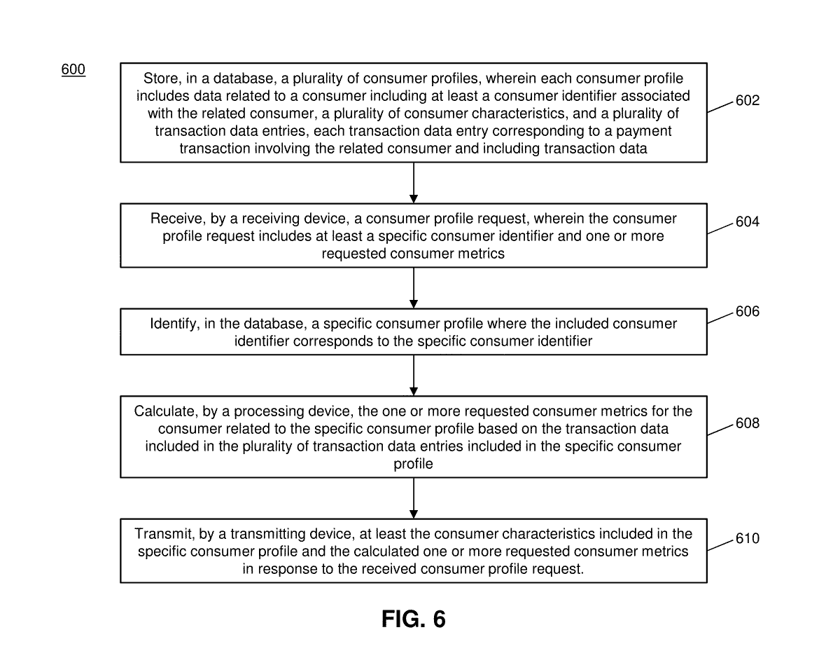

FIG. 6 illustrates a method 600 for the distributing of consumer analytics to a point of sale device based on consumer transaction history.

In step 602, a plurality of consumer profiles (e.g., consumer profiles 208) may be stored, in a database (e.g., the consumer database 110), wherein each consumer profile 208 includes data related to a consumer (e.g., the consumer 102) including at least a consumer identifier associated with the related consumer 102, a plurality of consumer characteristics, and a plurality of transaction data entries, each transaction data entry corresponding to a payment transaction involving the related consumer 102 and including transaction data. In one embodiment, the plurality of consumer characteristics may not be personally identifiable. In some embodiments, the plurality of consumer characteristics may include at least one of: age, gender, income, marital status, familial status, residential status, occupation, education, zip code, postal code, street address, county, city, state, and country.

In one embodiment, each transaction data entry may further include at least the consumer identifier associated with the related consumer 102 and a merchant identifier associated with a merchant involved in the corresponding payment transaction. In some embodiments, the transaction data may include at least one of: a transaction amount, product data, transaction time and/or date, geographic location, coupon data, and point-of-sale identifier.

In step 604, a consumer profile request may be received, by a receiving device (e.g., the receiving unit 202), wherein the consumer profile request includes at least a specific consumer identifier and one or more requested consumer metrics. In step 606, a specific consumer profile 208 may be identified, in the database 110, where the included consumer identifier corresponds to the specific consumer identifier.

In step 608, the one or more requested consumer metrics may be calculated, by a processing device (e.g., the processing unit 204), for the consumer 102 related to the specific consumer profile 208 based on the transaction data included in the plurality of transaction data entries included in the specific consumer profile 208. In one embodiment, the one or more consumer metrics may include at least one of: spending behaviors, spending propensities, consumer models, consumer trends, and predictive behaviors.

In step 610, a transmitting device (e.g., the transmitting unit 206) may transmit at least the consumer characteristics included in the specific consumer profile 208 and the calculated one or more requested consumer metrics in response to the received consumer profile request. In one embodiment, the consumer profile request may further include one or more selected consumer characteristics, and the consumer characteristics transmitted in response to the received consumer profile request may include the one or more selected consumer characteristics.

### Second Exemplary Method for Distributing Consumer Analytics

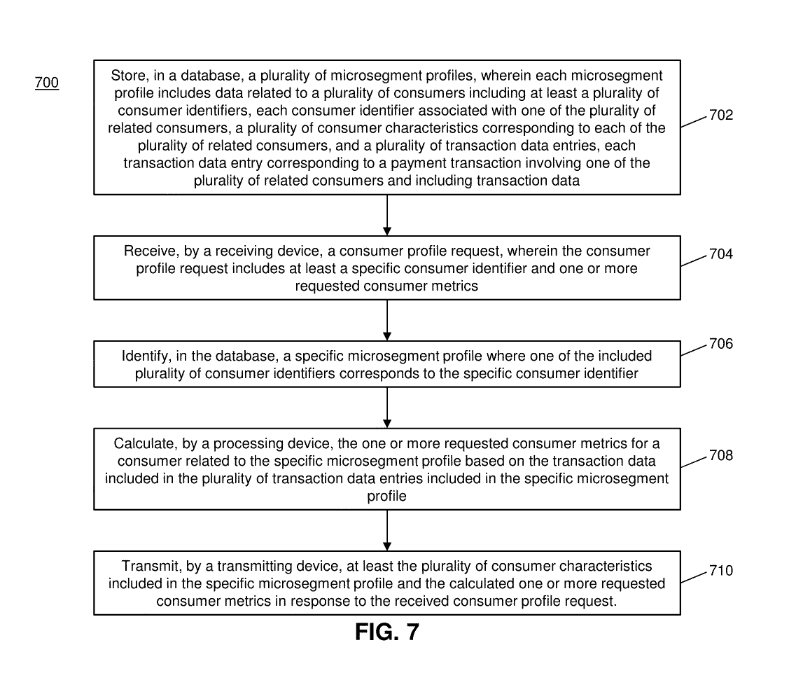

FIG. 7 illustrates an alternative method 700 for the distributing of consumer analytics to a point of sale device based on consumer transaction history of a microsegment of consumers.

In step 702, a plurality of microsegment profiles (e.g., microsegment profiles 212) may be stored, in a database (e.g., the microsegment database 210), wherein each microsegment profile 212 includes data related to a plurality of consumers (e.g., consumers 102) including at least a plurality of consumer identifiers, each consumer identifier associated with one of the plurality of related consumers 102, a plurality of consumer characteristics corresponding to each of the plurality of related consumers 102, and a plurality of transaction data entries, each transaction data entry corresponding to a payment transaction involving one of the plurality of related consumers 102 and including transaction data.

In one embodiment, the plurality of consumer characteristics may include at least one of: age, gender, income, marital status, familial status, residential status, occupation, education, zip code, postal code, street address, county, city, state, and country. In some embodiments, each transaction data entry may further include at least a consumer identifier associated with one of the plurality of related consumers involved in the corresponding payment transaction and a merchant identifier associated with a merchant (e.g., the merchant 104) involved in the corresponding payment transaction. In one embodiment, the transaction data may include at least one of: a transaction amount, product data, transaction time and/or date, geographic location, coupon data, and point-of-sale identifier.

In step 704, a consumer profile request may be received, by a receiving device (e.g., the receiving unit 202), wherein the consumer profile request includes at least a specific consumer identifier and one or more requested consumer metrics. In step 706, a specific microsegment profile 212 may be identified, in the database 210, where one of the included plurality of consumer identifiers corresponds to the specific consumer identifier.

In step 708, the one or more requested consumer metrics may be calculated, by a processing device (e.g., the processing unit 204), for a consumer 102 related to the specific microsegment profile 212 based on the transaction data included in the plurality of transaction data entries included in the specific microsegment profile 212. In one embodiment, the one or more consumer metrics may include at least one of: spending behaviors, spending propensities, consumer models, consumer trends, and predictive behaviors.

In step 710, a transmitting device (e.g., the transmitting unit 206) may transmit at least the plurality of consumer characteristics included in the specific microsegment profile 212 and the calculated one or more requested consumer metrics in response to the received consumer profile request. In one embodiment, the consumer profile request may further include one or more selected consumer characteristics, and the consumer characteristics transmitted in response to the received consumer profile request may include the one or more selected consumer characteristics.

### Computer System Architecture

FIG. 8 illustrates a computer system 800 in which embodiments of the present disclosure, or portions thereof, may be implemented as computer-readable code. For example, the processing server 108 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A-3C and 5-7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3A-3C and 5-7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

Techniques consistent with the present disclosure provide, among other features, systems and methods for distributing consumer analytics to a point of sale device. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for distributing consumer analytics to a point-of-sale device, comprising:
storing, in a database, a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer and including transaction data;
receiving, by a receiving device, a consumer profile request, wherein the consumer profile request includes at least a specific consumer identifier and one or more requested consumer metrics;
identifying, in the database, a specific consumer profile where the included consumer identifier corresponds to the specific consumer identifier;
calculating, by a processing device, the one or more requested consumer metrics for the consumer related to the specific consumer profile based on the transaction data included in the plurality of transaction data entries included in the specific consumer profile; and
transmitting, by a transmitting device, at least the consumer characteristics included in the specific consumer profile and the calculated one or more requested consumer metrics in response to the received consumer profile request.

2. The method of claim 1, wherein the consumer profile request further includes one or more selected consumer characteristics, and wherein the consumer characteristics transmitted in response to the received consumer profile request include the one or more selected consumer characteristics.

3. The method of claim 1, wherein the plurality of consumer characteristics includes at least one of: age, gender, income, marital status, familial status, residential status, occupation, education, zip code, postal code, street address, county, city, state, and country.

4. The method of claim 1, wherein each transaction data entry further includes at least a consumer identifier associated with the related consumer and a merchant identifier associated with a merchant involved in the corresponding payment transaction.

5. The method of claim 1, wherein the transaction data includes at least one of: a transaction amount, product data, transaction time and/or date, geographic location, coupon data, and point-of-sale identifier.

6. The method of claim 1, wherein the plurality of consumer characteristics are not personally identifiable.

7. The method of claim 1, wherein the one or more consumer metrics include at least one of: spending behaviors, spending propensities, consumer models, consumer trends, and predictive behaviors.

8. A method for distributing consumer analytics to a point-of-sale device, comprising:
storing, in a database, a plurality of microsegment profiles, wherein each microsegment profile includes data related to a plurality of consumers including at least a plurality of consumer identifiers, each consumer identifier associated with one of the plurality of related consumers, a plurality of consumer characteristics corresponding to each of the plurality of related consumers, and a plurality of transaction data entries, each transaction data entry corresponding to a payment transaction involving one of the plurality of related consumers and including transaction data;
receiving, by a receiving device, a consumer profile request, wherein the consumer profile request includes at least a specific consumer identifier and one or more requested consumer metrics;
identifying, in the database, a specific microsegment profile where one of the included plurality of consumer identifiers corresponds to the specific consumer identifier;
calculating, by a processing device, the one or more requested consumer metrics for a consumer related to the specific microsegment profile based on the transaction data included in the plurality of transaction data entries included in the specific microsegment profile; and
transmitting, by a transmitting device, at least the plurality of consumer characteristics included in the specific microsegment profile and the calculated one or more requested consumer metrics in response to the received consumer profile request.

9. The method of claim 8, wherein the consumer profile request further includes one or more selected consumer characteristics, and wherein the consumer characteristics transmitted in response to the received consumer profile request include the one or more selected consumer characteristics.

10. The method of claim 8, wherein the plurality of consumer characteristics includes at least one of: age, gender, income, marital status, familial status, residential status, occupation, education, zip code, postal code, street address, county, city, state, and country.

11. The method of claim 8, wherein each transaction data entry further includes at least a consumer identifier associated with one of the plurality of related consumers involved in the corresponding payment transaction and a merchant identifier associated with a merchant involved in the corresponding payment transaction.

12. The method of claim 8, wherein the transaction data includes at least one of: a transaction amount, product data, transaction time and/or date, geographic location, coupon data, and point-of-sale identifier.

13. The method of claim 8, wherein the one or more consumer metrics include at least one of: spending behaviors, spending propensities, consumer models, consumer trends, and predictive behaviors.

14. A system for distributing consumer analytics to a point-of-sale device, comprising:
a database configured to store a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer and including transaction data;
a receiving device configured to receive a consumer profile request, wherein the consumer profile request includes at least a specific consumer identifier and one or more requested consumer metrics;
a processing device configured to
identify, in the database, a specific consumer profile where the included consumer identifier corresponds to the specific consumer identifier, and
calculate the one or more requested consumer metrics for the consumer related to the specific consumer profile based on the transaction data included in the plurality of transaction data entries included in the specific consumer profile; and
a transmitting device configured to transmit at least the consumer characteristics included in the specific consumer profile and the calculated one or more requested consumer metrics in response to the received consumer profile request.

15. The system of claim 14, wherein the consumer profile request further includes one or more selected consumer characteristics, and wherein the consumer characteristics transmitted in response to the received consumer profile request include the one or more selected consumer characteristics.

16. The system of claim 14, wherein the plurality of consumer characteristics includes at least one of: age, gender, income, marital status, familial status, residential status, occupation, education, zip code, postal code, street address, county, city, state, and country.

17. The system of claim 14, wherein each transaction data entry further includes at least a consumer identifier associated with the related consumer and a merchant identifier associated with a merchant involved in the corresponding payment transaction.

18. The system of claim 14, wherein the transaction data includes at least one of: a transaction amount, product data, transaction time and/or date, geographic location, coupon data, and point-of-sale identifier.

19. The system of claim 14, wherein the plurality of consumer characteristics are not personally identifiable.

20. The system of claim 14, wherein the one or more consumer metrics include at least one of: spending behaviors, spending propensities, consumer models, consumer trends, and predictive behaviors.

21. A system for distributing consumer analytics to a point-of-sale device, comprising:
a database configured to store a plurality of microsegment profiles, wherein each microsegment profile includes data related to a plurality of consumers including at least a plurality of consumer identifiers, each consumer identifier associated with one of the plurality of related consumers, a plurality of consumer characteristics corresponding to each of the plurality of related consumers, and a plurality of transaction data entries, each transaction data entry corresponding to a payment transaction involving one of the plurality of related consumers and including transaction data;
a receiving device configured to receive a consumer profile request, wherein the consumer profile request includes at least a specific consumer identifier and one or more requested consumer metrics;
a processing device configured to
identify, in the database, a specific microsegment profile where one of the included plurality of consumer identifiers corresponds to the specific consumer identifier, and
calculate the one or more requested consumer metrics for a consumer related to the specific microsegment profile based on the transaction data included in the plurality of transaction data entries included in the specific microsegment profile; and
a transmitting device configured to transmit at least the plurality of consumer characteristics included in the specific microsegment profile and the calculated one or more requested consumer metrics in response to the received consumer profile request.

22. The system of claim 21, wherein the consumer profile request further includes one or more selected consumer characteristics, and wherein the consumer characteristics transmitted in response to the received consumer profile request include the one or more selected consumer characteristics.

23. The system of claim 21, wherein the plurality of consumer characteristics includes at least one of: age, gender, income, marital status, familial status, residential status, occupation, education, zip code, postal code, street address, county, city, state, and country.

24. The system of claim 21, wherein each transaction data entry further includes at least a consumer identifier associated with one of the plurality of related consumers involved in the corresponding payment transaction and a merchant identifier associated with a merchant involved in the corresponding payment transaction.

25. The system of claim 21, wherein the transaction data includes at least one of: a transaction amount, product data, transaction time and/or date, geographic location, coupon data, and point-of-sale identifier.

26. The system of claim 21, wherein the one or more consumer metrics include at least one of: spending behaviors, spending propensities, consumer models, consumer trends, and predictive behaviors.
